(19) United States
(12) Patent Application Publication
(10) Pub. No.: US 2010/0072240 A1
(43) Pub. Date: Mar. 25, 2010

(54) TRAILER HITCH MOUNTED VISE AND ANVIL

(76) Inventor: Howard Ray Cornes, Simi Valley, CA (US)

Correspondence Address: DONALD W. MEEKER, 924 EAST OCEAN FRONT, # E, NEWPORT BEACH, CA, 92661, US

(21) Appl. No.: 12/234,631

(22) Filed: Sep. 20, 2008

(51) Int. Cl. B60R 11/00

(52) U.S. Cl. 224/536

(57) ABSTRACT

A vise body has a trailer hitch insert beam which slides into a trailer hitch receiver on the back of a vehicle at four different angles of use. An adjustment nut driver on the end of the vise is turned with any of a variety of tools to adjust the vice gripping jaws. The vise may be turned and mounted sideways for use as an anvil. A bench mounted replicated hitch receiver receives the trailer hitch insert beam to use the vise on a workbench.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to attachments for existing trailer hitch hardware and particularly to a trailer hitch mounted vise which comprises a vise body, a trailer hitch insert beam which slides into a trailer hitch receiver on the back of a vehicle, and an adjustment nut driver on the end of the vise which is turned with a wrench to adjust the vice gripping jaws, wherein the vise may alternately be turned and mounted sideways for use as an anvil.

2. Description of Related Art Including Information Disclosed under 37 CFR 1.97 and 1.98

Tools such as vises are necessary for firmly holding work pieces so that a worker can perform various operations on the work piece. Most vises are secured to a workbench for use in a shop. Some workers must travel to and from job sites and simply bolt a vise directly to a sturdy portion of their vehicle so that the vise can be available when required.

While some prior art vise devices exist for use with vehicles, they do not adequately address the problems of exposure to outdoor environments and often do not provide versatility of use and ease of operation.

U.S. Pat. No. 5,433,356, issued Jul. 18, 1995 to Russell, indicates a vise having a fixed inner member with a stationary jaw and an elongate extension for inserting into and mounting to a trailer receiver attached to a motor vehicle, thus providing a vise for use in the field. The vise has a movable outer member and jaw operated by a threaded shaft and turned by a handle. The vise can be securely attached to receiver by a pin in one of four positions: upright, inverted, on its right side, on its left side.

U.S. Patent Application #20070290480, published Dec. 20, 2007 by Wolter, illustrates a vise attachment for use with a trailer hitch. The attachment comprises a sleeve inserted in the hitch and secured to the hitch. On the outer end of the sleeve is plate to which is affixed a vise. The vise is used to clamp objects in place so they can be worked upon. The plate, which can be round, oval, square, rectangular, provides a work surface to assist the person using the attachment work on the clamped object. U.S. Pat. No. D468,681, issued Jan. 14, 2003 to Rath, provides the ornamental design for an utility mount for use with trailer hitch receiver, which is shown with a vise being included solely for illustrative purposes.

U.S. Pat. No. 5,890,739, issued Apr. 6, 1999 to Cogswell, Sr., claims a vertically adjustable hitch mounted vice. A vice mounted on a vehicle is provided including a vehicle with an adjustable vertical mounting mechanism coupled to a rear extent thereof. Further provided is a vice coupled to the adjustable vertical mounting mechanism.

U.S. Pat. No. 4,705,254, issued Nov. 10, 1987 to Swanson, discloses an adjustable and removable vice assembly for use on a vehicle comprising an elongated receiving member fixedly mountable on a rear end portion of a vehicle in generally parallel alignment with a longitudinal axis of the vehicle; an elongated support member receivable in the receiving member in rearwardly extending relationship therewith; and longitudinally slidably adjustable with respect thereto; a slide member which is vertically slidingly adjustable with respect to the elongated support member; a vice mounted on the slide member; and stabilizing and holding devices associated with the receiving member, the support member and the slide member for selectively stably holding the members in a selected fixed relationship.

U.S. Pat. No. 7,240,707, issued Jul. 10, 2007 to Schweitzer, illustrates a portable work bench station having a base with a flat plate having four holes for securing to the work bench. The base has a longitudinal hollow receiver opening to the outside edge of the work bench. The portable work bench station has a receiver arm having outside dimensions smaller than the inside dimensions of the longitudinal hollow hitch receiver so the receiver arm mates to and slidingly engages the hollow interior diameter of the longitudinal hollow receiver in telescopic fashion. The receiver arm has a mounting plate. The portable work bench station has an L-shaped tool mount which adjustably attaches to the mounting plate and to which is attached the tool to be used. The L-shaped tool mount has a horizontal wing and a vertical wing. The vertical wing is secured to the mounting plate and the horizontal wing has a plurality of apertures for receiving a fastening device such that a tool, vise, grinder, etc., can be securely fastened to the L-shaped tool mount.

U.S. Pat. No. 5,267,748, issued Dec. 7, 1993 to Curran, indicates a vehicle tool platform apparatus adapted for use with and attachment to a work type truck having a rear tailgate or a van with rear doors, said truck or van having a rear trailer hitch. A vehicle tool platform apparatus comprising a flat tool platform, elongated angle support bar having one end secured to the bottom surface of the tool platform and the other end adapted to be received and secured in the rear trailer hitch. A work tool, such as a vise, bench grinder or saw, is secured to the top surface of the tool platform. The angle and length of the support rod is designed so that the plane of the tool platform is at a height generally level with the floor of the van or the bed of the truck to which the work platform apparatus is to be secured. Further, the platform is positioned a sufficient distance from the rear of the vehicle to which the work platform is to be secured to permit the doors of the vehicle to be opened fully, or the tailgate of the truck to be lowered to a plane level with and adjacent to the top surface of the work platform apparatus.

U.S. Pat. No. 5,082,037, issued Jan. 21, 1992 to Hammons, describes an apparatus for mounting tools and other devices, which is capable of adjustment in both the vertical and horizontal directions relative to a box receiver mounted on the bumper of a vehicle. An L-shaped support section at its one end slidingly engages and is fixed to a box receiver mounted on a vehicle bumper. At its other end, L-shaped support section slidingly engages a second support member which has a mounting plate fixed thereto. The mounting plate is provided with a number of holes or elongated slots to provide means for mounting tools, motors, vises, and the like, to provide a secure mounting platform at remote locations, such as construction sites or campgrounds.

U.S. Pat. No. 4,576,395, issued Mar. 18, 1986 to Longoria, puts forth a trailer hitch mounted tool support comprising an upstanding support which is open at its lower end for snug downward telescoping over an upwardly projecting hitch ball supported from a hitch tongue of a width greater than the diameter of the ball. The lower end of the upstanding support is downwardly abuttable against the upwardly facing surfaces of the hitch tongue spaced immediately outward of an upstanding cylindrical zone containing the outer periphery of the hitch ball and the support includes a plurality of circumferentially spaced clamp screws threadingly supported therefrom with the innermost ends of the clamp screws being clampingly engageable with the reduced diameter shank portion of the hitch ball spaced closely above the hitch tongue. The upper end of the upstanding support mounts a horizontal mounting plate therefrom which may be utilized to support a plurality of different objects such as a grinder, workbench, hoist, cycle carrier, sign, floodlight, pipe rack and the like.

U.S. Pat. No. 6,511,088, issued Jan. 28, 2003 to Kahlstorf, is for a versatile trailer hitch mounting system which enables mounting of heavy duty equipment to existing trailer hitch hardware currently found on pickups, vans, SUV's, recreational vehicles, and automobiles. The type of heavy duty equipment that could be attached to the apparatus of the invention would include a heavy duty table, a work station, a vise, a spool and/or a winch, and a level working surface.

U.S. Patent Application #20080061097, published Mar. 13, 2008 by Milender, concerns a work platform attachment which attaches to the vehicle's trailer hitch. A device such as a barbecue, tool, etc. is attached to the work platform plate. The plate is attached to a series of tubular members that connect to one another and ultimately to the vehicle's trailer hitch. The plate is easily removed, allowing the user to either use the plate or to easily attach other attachments to the hollow pole. Therefore, the user can quickly and easily perform a variety of activities at variable heights behind the vehicle.

What is needed is a trailer hitch mounted vise which comprises a vise body, a trailer hitch insert beam which slides into a trailer hitch receiver on the back of a vehicle and may be inserted at four different angles of use, and an adjustment nut driver on the end of the vise which is turned with any of a variety of tools to adjust the vice gripping jaws, wherein the vise may alternately be turned and mounted sideways for use as an anvil.

### BRIEF SUMMARY OF THE INVENTION

An object of the present invention is to provide a trailer hitch mounted vise which comprises a vise body, a trailer hitch insert beam which slides into a trailer hitch receiver on the back of a vehicle and may be inserted at four different angles of use, and an adjustment nut driver on the end of the vise which is turned with any of a variety of tools to adjust the vice gripping jaws, wherein the vise may alternately be turned and mounted sideways for use as an anvil.

In brief, the trailer hitch mounted vise and anvil of the present invention is to be used in the towing receiver of any vehicle in any of four orientations and can be used as a anvil. Can be used at home or any location with base attachment. The typical handle is not used and a ½″ square hole nut driver with an outer 13/16″ hex head is used. A ratchet or wrench or tire iron/lug wrench may be used to work the vise. By using a ratchet or wrench gives the person working better leverage. When not in use ratchet or wrench is removed for storage.

Advantages of the present invention include that it is portable, is lighter than a standard vise, is easy to store, has no handle in the way, provides an anvil is clear of any obstructions, mounts to any trailer hitch receiver allowing use in any location, alternately mounts to work bench at home or in shop with bench mount, rotates to one of four desired clamping angles, uses a wrench, ratchet or tire iron to allow a user to get maximum torque in adjusting the vice, and has interior components enclosed including a seal around the nut driver and screw keeps device clean and working smoothly.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a perspective view of the vehicle mounted vise of the present invention showing the movable vise jaw attached to the stationary vise jaw which attaches at four different angles to a vehicle trailer hitch receiver;

FIG. 2 is a perspective view of the stationary vise jaw of FIG. 1 which attaches at four different angles to a vehicle trailer hitch receiver showing a stationary outer threaded shaft inside a receiving sleeve for receiving an adjustable inner threaded tube inside a guide beam on the movable vise jaw;

FIG. 3 is an exploded perspective view of the stationary vise jaw of FIG. 2 showing the parts of the stationary vise jaw aligned for assembly;

FIG. 4 is a perspective view of the movable vise jaw of FIG. 1 showing an outer end nut driver for turning an adjustable inner threaded tube inside a guide beam on the movable vise jaw to mate with the stationary outer threaded shaft inside the receiving sleeve in the stationary vise jaw;

FIG. 5 is an exploded perspective view of the movable vise jaw of FIG. 4 showing the parts of the movable vise jaw aligned for assembly;

FIG. 6 is a perspective view of a vise holding stand which is mounted on a work bench with a replicated trailer hitch receiver sleeve with at least one pin opening through at least one wall for receiving the square vise insertion tube for use of the vehicle mounted vise device in a building on a workbench;

FIG. 7 is a side elevational view of the vise holding stand of FIG. 6.

### DETAILED DESCRIPTION OF THE INVENTION

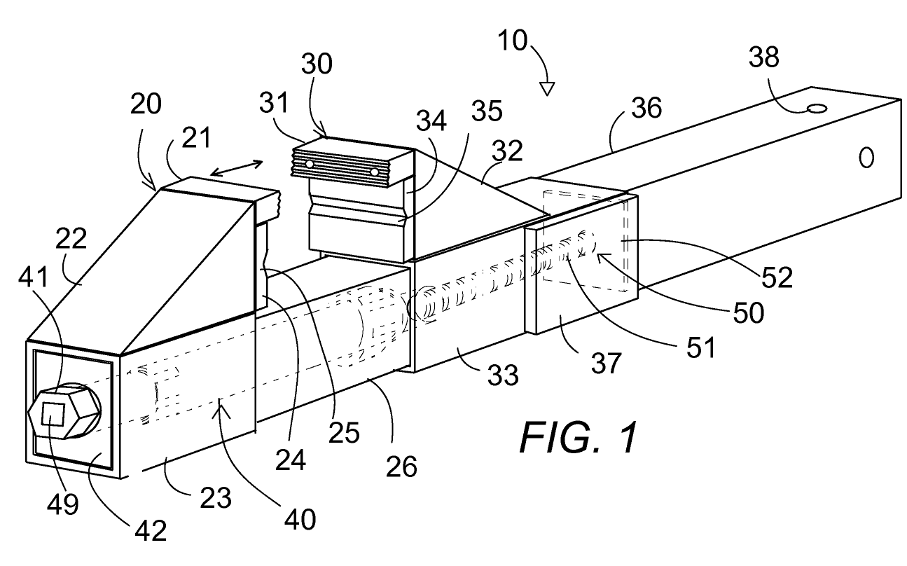

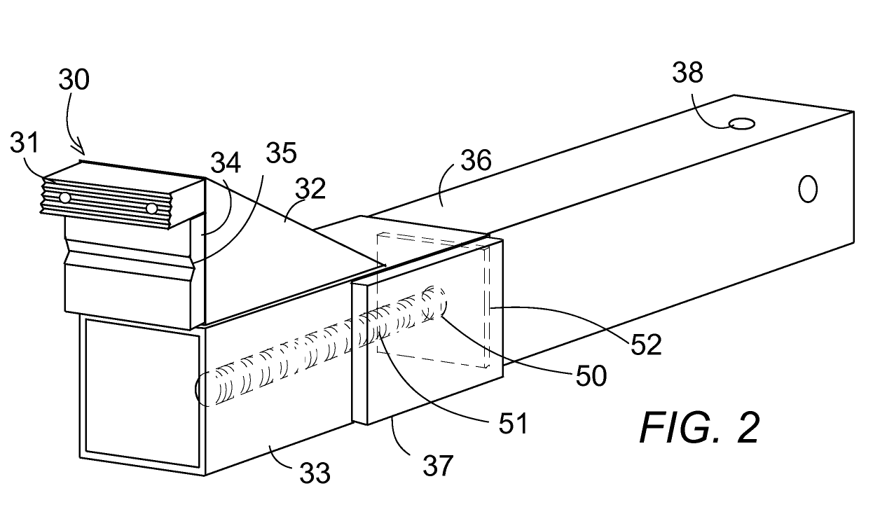

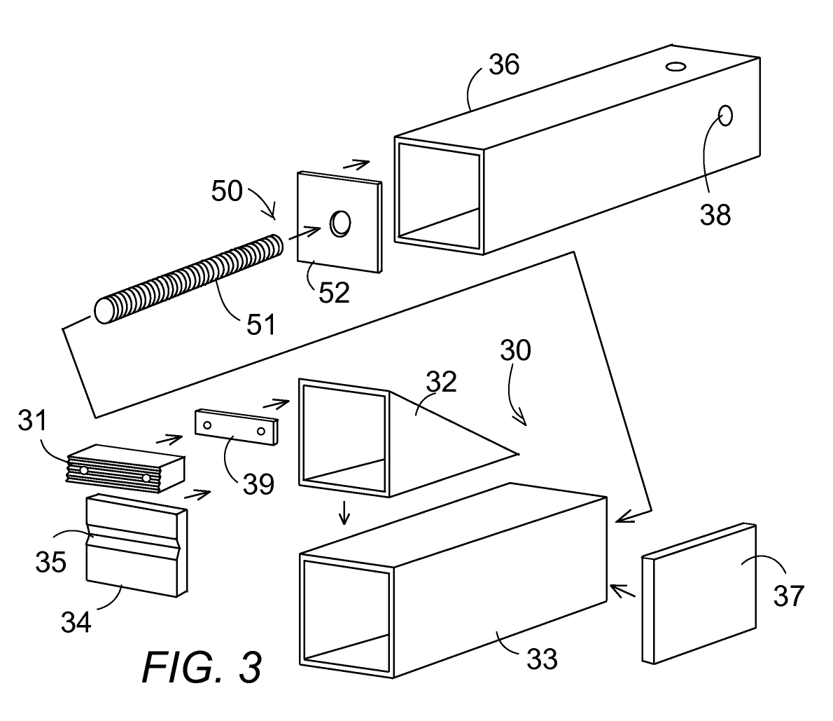

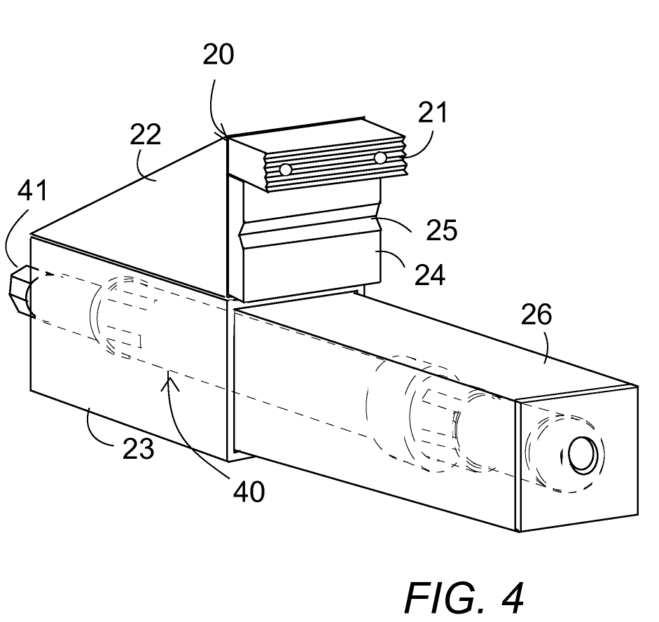

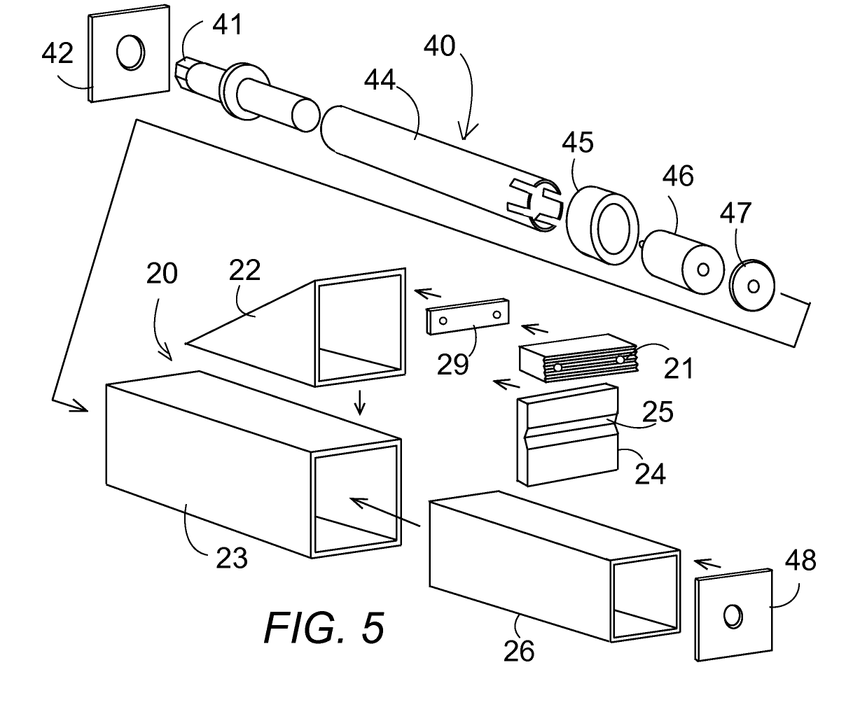

In FIGS. 1-7, a vehicle mounted vise device 10 comprises a stationary vise jaw 30 attachable to a vehicle jack receptacle and a movable vise jaw 20 adjustably attached to the stationary vise jaw 30.

In FIG. 1, the pair of vise jaws 20 and 30 interact with the movable vise jaw 20 moving toward and away from the stationary vise jaw, as indicated by the two-headed arrow, to hold items within the pair of adjustable vise jaws for working on the items. The pair of vise jaws are removably attached to a square tubular trailer hitch receiver tube within the trailer hitch receive tube. The pair of vise jaws may be positioned in any of four orientations within the square trailer hitch receiver tube including up and down and right and left, by removing and reinserting the pair of vise jaws within the trailer hitch receiving tube with the vise jaws in the desired orientation.

In FIGS. 1-3, the stationary vise jaw 30 comprises an elongated square vise insertion tube 36 slightly smaller in outside dimensions than an interior opening in the square trailer hitch receiver tube so that the vise insertion tube slides in and out with a loose friction fit. The vise insertion tube 36 has a pin receiving opening 38 through each of the four sides of the vise insertion tube 36 to mate with a pin insertion opening in one side of the trailer hitch receiver tube to secure the vise insertion tube therein in any of four positions.

The stationary vise jaw 30 further comprises a stationary jaw 32 facing outwardly away from an outer end of the vise insertion tube 36. The stationary jaw comprising a stationary jaw textured gripping surface 31 bolted to a screw plate 39 welded to the stationary jaw 32 and a stationary jaw notched pipe receiving surface 34 with recessed pipe receiving notch 35 also welded to the stationary jaw 32. An anvil plate 37 is rigidly attached to at least one side of a receiving sleeve 33 of the stationary vise head 30 for use as an anvil which can be oriented horizontally or vertically by turning the stationary vise jaw 30 in the trailer hitch receiver. The stationary jaw 32 is welded on top of the receiving sleeve 33.

A means for receiving a movable vise jaw connection in an outer face of the stationary vise jaw comprises a receiving sleeve 33 having an outer receiving opening in the outer face of the stationary jaw and an outer threaded stationary shaft 51 inside the receiving sleeve 33, which threaded stationary shaft 51 is welded to a shaft receiving plate 52 welded to the vise insertion tube 36. The threaded connector of the movable vise jaw 20 comprises a mating inner threaded tubular member 40 on the movable vise jaw controlled by the universal nut driver 41 welded to the tubular member and the guide member comprises a protruding rigid guide post 26 extending from an inner face of the movable vise jaw fitting slidably within the receiving sleeve 33 of the stationary vise jaw 30. The universal nut driver 41 extends from on outer end of the movable vise jaw 20 for receiving any of a variety of gripping means for turning the universal nut driver, the universal nut driver communicating with the threaded connector 40 for adjusting the movable vise jaw 20 relative to the stationary vise jaw 30.

The gripping means for turning the universal nut driver 41 may comprise at least one of the gripping means taken from the list of gripping means comprising a rigid head wrench, an adjustable head wrench, a vehicle lug wrench, and a ratchet wrench.

An outer face of the universal nut driver has a central multisided geometrical opening 49, preferably square as shown in FIG. 1, therein for receiving a gripping means for turning the universal nut driver 41 comprises at least one of the gripping means taken from the list of gripping means comprising an Allen wrench, a tire iron, and a handle having a mating multisided geometrical end.

In FIGS. 1, 4 and 5, the movable vise jaw 20 is adjustably connected to the stationary vise jaw 30 for holding items therebetween, the movable vise jaw comprises a movable jaw 22 facing inwardly from an inner end of the movable vise jaw 20. The movable jaw comprises a movable jaw textured gripping surface 21 bolted to a movable jaw screw plate 29 welded to the movable jaw 22 to mate with the stationary jaw textured gripping surface 31 and a movable jaw notched pipe receiving surface 24 with a recessed pipe receiving notch 25 also welded to the movable jaw 22 to mate with the stationary jaw notched pipe surface 34 and stationary jaw recessed pipe receiving notch 35 to secure cylindrical items therebetween. The movable jaw body 22 is welded on top of a movable jaw support 23. An outer nut driver end cap plate 42 is welded to the outer face of the movable jaw support 23. The insertion beam 26 is welded to the inner portion of the movable jaw support 23 and an end plate 48 welded to the exposed end of the insertion beam 26 with a center opening in the end plate to receive the stationary threaded shaft 51 of the stationary vise jaw 30. The inner threaded tubular member 40 comprises an assembly of welded components including the outer end nut driver 41, a connected nut tube 44, encircling ring 45, connected inner threaded member 46 and washer 47.

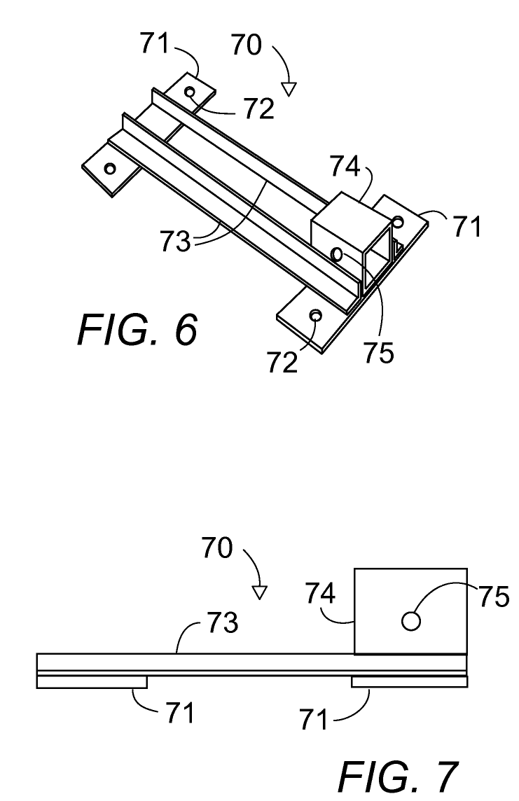

In FIGS. 6 and 7, a vise holding stand 70 is mounted by screws through holes 72 brackets 71 onto a work bench, A replicated trailer hitch receiver sleeve 74 with at least one pin opening 75 through at least one wall for receiving the square vise insertion tube 36 for use of the vehicle mounted vise device in a building on a workbench. L-shaped angle beams 73 between the brackets 71 provide leverage to hold the sleeve 74.

The stationary vise jaw 30 and the movable vise jaw 20 have close tolerance fits between moving parts and are each sealed to prevent particles and moisture from penetrating into interior spaces preventing malfunction and prolonging the live of the device. The permanently connected parts of the device are preferably welded together.

It is understood that the preceding description is given merely by way of illustration and not in limitation of the invention and that various modifications may be made thereto without departing from the spirit of the invention as claimed.

What is claimed is:

1. A vehicle mounted vise device comprising:
a pair of vise jaws interacting to hold items within the pair of adjustable vise jaws, the pair of vise jaws removably attached to a square tubular trailer hitch receiver tube within the trailer hitch receive tube, the pair of vise jaws positioned in any of four orientations within the square trailer hitch receiver tube including up and down and right and left, by removing and reinserting the pair of vise jaws within the trailer hitch receiving tube with the vise jaws in the desired orientation, the pair of vise jaws comprising:
a stationary vise jaw comprising an elongated square vise insertion tube slightly smaller in outside dimensions than an interior opening in the square trailer hitch receiver tube so that the vise insertion tube slides in and out with a loose friction fit, the vise insertion tube having a pin receiving opening through each of the four sides of the vise insertion tube to mate with a pin insertion opening in one side of the trailer hitch receiver tube to secure the vise insertion tube therein in any of four positions; the stationary vise jaw further comprising a an outwardly stationary jaw facing at an outer end of the vise insertion tube, the stationary jaw comprising a stationary jaw textured gripping surface and a stationary jaw notched pipe receiving surface, a means for receiving a movable vise jaw connection in an outer face of the stationary vise jaw;
a movable vise jaw adjustably connected to the stationary vise jaw for holding items therebetween, the movable vise jaw comprising a threaded connector and a guide member for connecting the movable vise jaw to the means for receiving the movable vise jaw connection of the stationary vise jaw; the movable vise jaw further comprising a movable jaw facing inwardly from an inner end of the movable vise jaw, the movable jaw comprising a movable jaw textured gripping surface to mate with the stationary jaw textured gripping surface and a movable jaw notched pipe receiving surface to mate with the stationary jaw notched pipe surface to secure cylindrical items therebetween; the movable jaw further comprising a universal nut driver extending from on outer end of the movable vise jaw for receiving any of a variety of gripping means for turning the universal nut driver, the universal nut driver communicating with the threaded connector for adjusting the movable vise jaw relative to the stationary vise jaw.

2. The device of claim 1 wherein the gripping means for turning the universal nut driver comprises at least one of the gripping means taken from the list of gripping means comprising a rigid head wrench, an adjustable head wrench, a vehicle lug wrench, a ratchet wrench.

3. The device of claim 1 wherein an outer face of the universal nut driver has a central multisided geometrical opening therein for receiving a gripping means for turning the universal nut driver comprises at least one of the gripping means taken from the list of gripping means comprising an Allen wrench, a tire iron, a handle having a mating multisided geometrical end.

4. The device of claim 1 wherein the means for receiving a movable vise jaw connection in an outer face of the stationary vise jaw comprises a receiving sleeve having an outer receiving opening in the outer face of the stationary jaw and an outer threaded stationary shaft inside the receiving sleeve and the threaded connector of the movable vise jaw comprises a mating inner threaded tubular member on the movable vise jaw controlled by the universal nut driver welded to the tubular member and the guide member comprises a protruding rigid guide post extending from an inner face of the movable vise jaw fitting slidably within the receiving sleeve of the stationary vise jaw.

5. The device of claim 1 further comprising an anvil plate rigidly attached to at least one side of the stationary vise head for use as an anvil.

6. The device of claim 1 wherein the stationary vise jaw and the movable vise jaw are each sealed to prevent particles and moisture from penetrating into interior spaces.

7. The device of claim 1 further comprising a vise holding stand mounted on a work bench comprising a replicated trailer hitch receiver sleeve with at least one pin opening through at least one wall for receiving the square vise insertion tube for use of the vehicle mounted vise device in a building on a workbench.
